(19) United States
(12) Patent Application Publication
(10) Pub. No.: US 2012/0205168 A1
(43) Pub. Date: Aug. 16, 2012

(54) ROBOT RECONFIGURABLE FOR INSERTION THROUGH A NARROW OPENING

(76) Inventors: Christopher Ryan Flynn, Nanaimo (CA); Roy Coles, Nanoose (CA); Allen Clifford Robinson, Nanaimo (CA); Seth William Broadfoot, Vicksburg, MS (US); Michael Scott Mattice, Sparta, NJ (US); Jason Ronald McKenna, Vicksburg, MS (US)

(21) Appl. No.: 13/025,655

(22) Filed: Feb. 11, 2011

(51) Int. Cl. B62D 63/02; B62D 55/065

(52) U.S. Cl. 180/9.1; 180/14.1

(57) ABSTRACT

A system for inserting a robot through an opening which includes a robot, the robot, payload, a tether, and a remote controller. The robot includes a first body supporting a first ground engaging drive and a second body supporting a second ground engaging drive. A pivoting connective linkage is provided between the first body and the second body. The connective linkage has an operative position in which the first body and the second body are in parallel spaced relation and an insertion position in which the first body and the second body are aligned on a common axis. An actuator is provided for moving the connective linkage from the insertion position to the operative position.

### STATEMENT REGARDING FEDERALLY SPONSORED RESEARCH

The U.S. Government has certain rights in this invention pursuant to contract No. ______, awarded by the U.S. Army Corps of Engineers, Engineer R&D Center (ERDC).

### FIELD

There is described a robot that has an operational configuration for normal operations and has an insertion configuration for insertion through a narrow opening.

### BACKGROUND

U.S. Patent Application 20050103538 (Cotton) describes a robot that has an operational configuration with tracks placed in parallel spaced relation and an insertion configuration with tracks placed in side by side relation for insertion through a narrow opening. Another example of a remotely controllable robot vehicle for inspecting the interior of underground tanks is disclosed in U.S. Pat. No. 7,296,488 (Hock, et al.). The robot vehicle is used for accessing ferrous surfaces such as those in underground tanks which are normally accessible only with special effort. There is a need for robots that are capable of fitting through narrower openings than the Cotton reference can accommodate and without the magnetic tracks of the Hock et al. reference.

### SUMMARY

There is provided a robot reconfigurable for insertion through a narrow opening. The robot includes a first body supporting a first ground engaging drive and a second body supporting a second ground engaging drive. A pivoting connective linkage is provided between the first body and the second body. The connective linkage has an operative position in which the first body and the second body are in parallel spaced relation and an insertion position in which the first body and the second body are aligned on a common axis. An actuator is provided for moving the connective linkage from the insertion position to the operative position.

The robot, as described above, when in the insertion position, provides distinct advantages over prior art in that the first body and the second body are aligned on a common axis for insertion. With the prior art, the first body and the second body were placed in side by side relation for insertion, which effectively doubled the cross-sectional dimension of the robot which had to be inserted through an opening.

In the description which follows more detail will be provided regarding the shape of the bodies and the mounting of the ground engaging drive on the body. Beneficial results have been obtained through use of a configuration in which the first body is elongated, has a first longitudinal axis and supports the first ground engaging drive in a position along the first longitudinal axis. Movement of the first body is forward or backwards in a direction defined by the first longitudinal axis. Similarly, the second body is elongated, has a second longitudinal axis and supports the second ground engaging drive in a position along the second longitudinal axis. Movement of the second body, as with the first body, is in a direction defined by the second longitudinal axis.

The preferred form of connective linkage is a parallelogram linkage. With a parallelogram linkage, two actuators can be used with one acting against each arm of the parallelogram linkage. This creates a built in redundancy. If one actuator should fail, the remaining functioning actuator can individually activate the parallelogram linkage.

In the detailed description which follows, the actuator is described as being a telescopically expandable cylinder which uses compressed air as a working fluid. It should be noted that hydraulic fluid could be used in place of compressed air. It should also be noted that solenoids and other electro-mechanical actuators could be used in substitution for a fluid powered actuator.

In the detailed description which follows, the ground engaging drive is described as being an endless track. It should be noted that a plurality of in line drive wheels would be an alternative form of drive and there are likely other forms of drive that could be made to function.

It is necessary to have an actuator to move the connective linkage from the insertion position to the operative position. It must be noted, that the robot is raised and lowered into a borehole at the end of a line. For this reason, it is not absolutely necessary for the actuator to be also capable of moving the connective linkage from the operative position to the insertion position. In the absence of an actuator, the connective linkage is moved from the operative position to the insertion position by force of gravity when suspended on a line.

In the detailed description which follows, the robot is described as carrying a camera. The camera is also positioned along a common axis when in the insertion position, so it does not restrict the diameter of opening into which the robot can be inserted. It should be noted that the camera illustrated is merely one form of “working instrument”. There are a wide variety of probes and other instruments that the robot could carry.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a right side front perspective view of a robot that is reconfigurable for insertion through a narrow opening;

FIG. 2 is a left side front perspective view, partially in section, of the robot illustrated in FIG. 1;

FIG. 3 is a side elevation view of the robot of FIG. 1, suspended in the insertion position;

FIG. 4 is a side elevation view of the robot of FIG. 1, suspended in the operative position;

FIG. 5 is a schematic view of the pneumatic controls for the control of the working instrument;

FIG. 6 is a schematic view of the pneumatic controls for the track configuration;

FIG. 7 is a exploded view of a controller; and

FIG. 8 is a perspective view of the robot, compressor, winch and controller.

### DETAILED DESCRIPTION

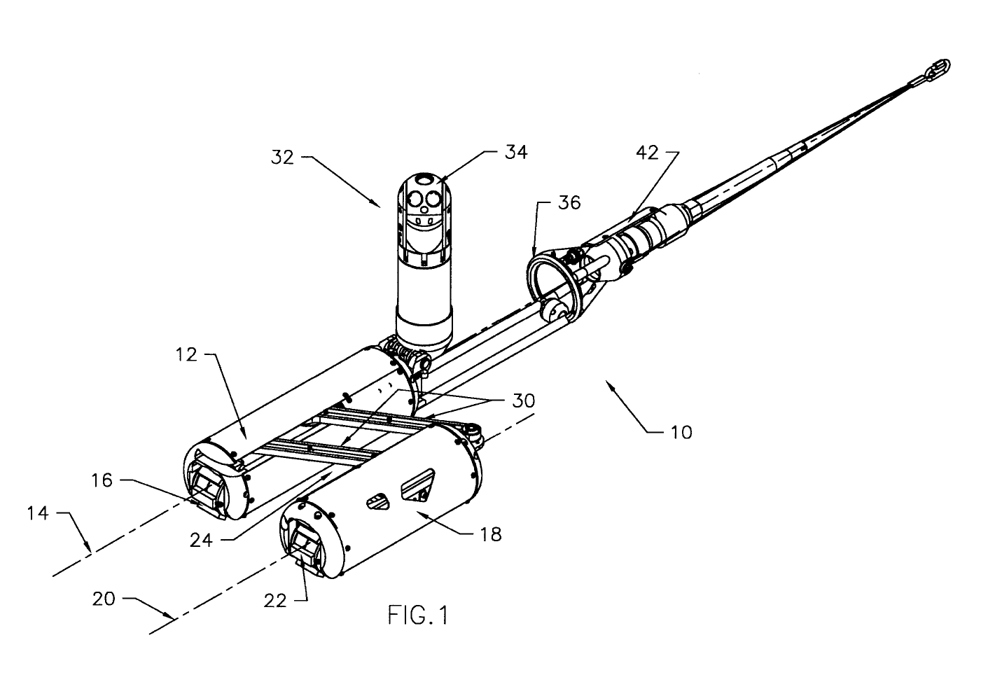

A robot that is reconfigurable for insertion through a narrow opening generally identified by reference numeral 10, will now be described with reference to FIGS. 1 through 8.

### Structure and Relationship of Parts:

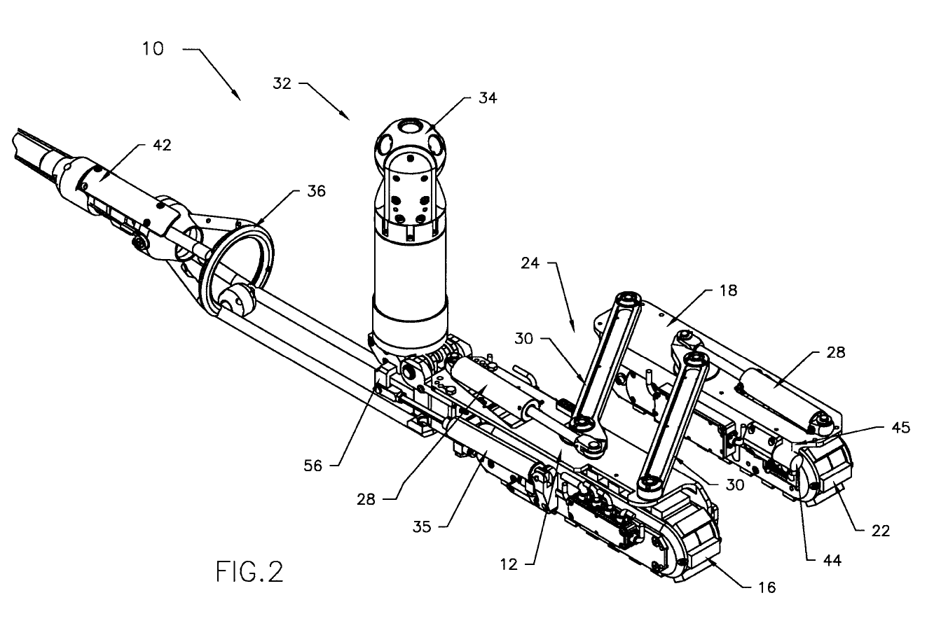

Referring to FIG. 1 and FIG. 2 there is illustrated a robot 10 that is reconfigurable for insertion through a narrow opening. Referring to FIG. 1, robot 10 has an elongated first body 12 with a first longitudinal axis 14. First body 12 supports a first ground engaging endless track 16 that is positioned along first longitudinal axis 14. Movement of first body 12 is forwards or backwards in a direction defined by first longitudinal axis 14. There is also provided an elongated second body 18 which has a second longitudinal axis 20. Second body 18 supports a second ground engaging endless track 22 positioned along second longitudinal axis 20. Movement of second body 18 is forwards or backwards in a direction defined by second longitudinal axis 20.

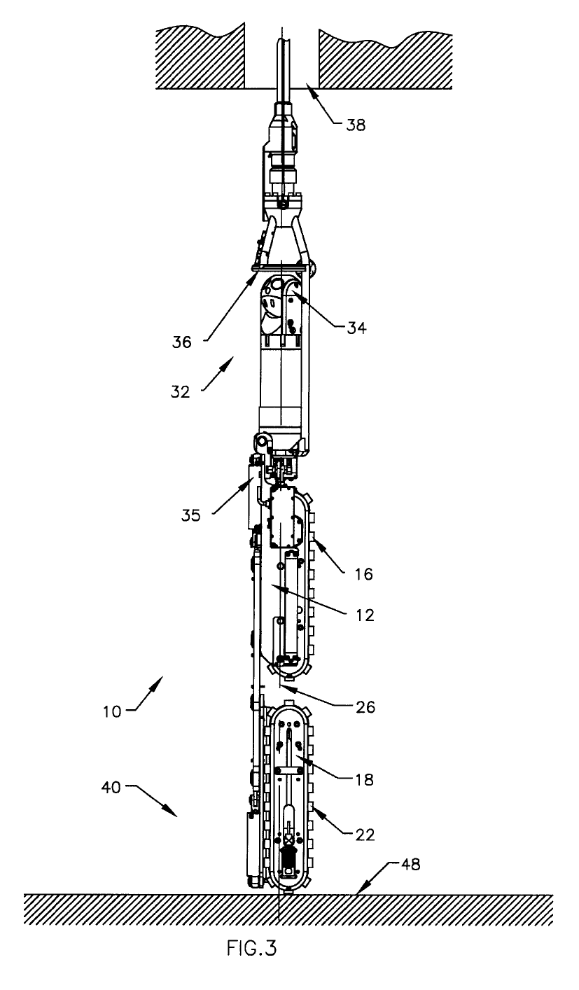

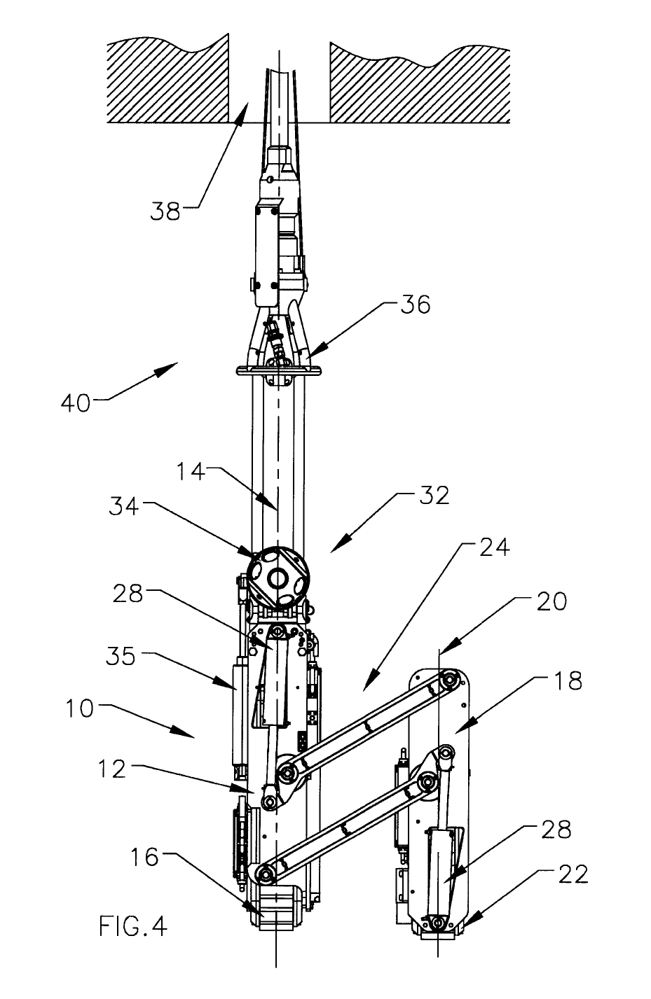

A pivoting parallelogram connective linkage 24, having two connective arms 30, is provided between first body 12 and second body 18. Connective linkage 24 has an operative position in which first body 12 and second body 18 are in parallel spaced relation as illustrated in FIG. 1 or FIG. 2 and an insertion position in which first body 12 and second body 18 are aligned on a common axis 26 as illustrated in FIG. 3. Referring to FIG. 2, two fluid actuated telescopically expandable actuators 28 are provided, with each acting against one of the two arms 30 of connective linkage 24 to exert a force upon connective linkage 24 to move connective linkage 24 from the insertion position illustrated in FIG. 3, to the operative position illustrated in FIG. 2 and FIG. 4. In the illustrated embodiment, the working fluid used for expanding actuators 28 is compressed air. It should be noted that hydraulic fluid could be used in place of compressed air. It should also be noted that solenoids and other electro-mechanical actuators could be used instead of fluid powered actuator 28.

Referring to FIG. 3 and FIG. 4, connective linkage 24 is moved from the operative position illustrated in FIG. 4 to the insertion position illustrated in FIG. 3 by force of gravity. Movement from the insertion position to the operative position is effected by actuators 28. It is preferred that two actuators 28 be used, although robot 10 could operate with only one actuator 28. With two actuators 28, if one actuator 28 should fail, the remaining functioning actuator 28 can individually activate connective linkage 24. The use of two actuators 28 also ensures that undue strain in not placed on an individual actuator.

Referring to FIG. 2, a working instrument 32 is pivotally attached to first body 12. In the illustrated embodiment, the working instrument 32 selected for illustration is a camera 34, but other instruments or probes could also be used, as required. Working instrument 32 is pivotally movable between an insertion position along first longitudinal axis 14 of first body 12 to which it is mounted as illustrated in FIG. 3. and an operative position in angular relation to first body 14 to which it is mounted as illustrated in FIG. 2. An ancillary actuator 35 is provided to move working instrument 32 between the insertion position illustrated in FIG. 3 and the operative position illustrated in FIG. 2. It will also be appreciated that working instrument 32 could also be attached to second body 18 instead of first body 12, and operate in a similar manner. In the illustrated embodiment, a protective cage 36 is provided for protecting camera 34 during insertion of robot 10.

Referring to FIG. 3 and FIG. 4, robot 10 is designed specifically for small-diameter entry into boreholes 38 and tunnels 40 for exploration and monitoring. It can also be used for a variety of other diverse applications.

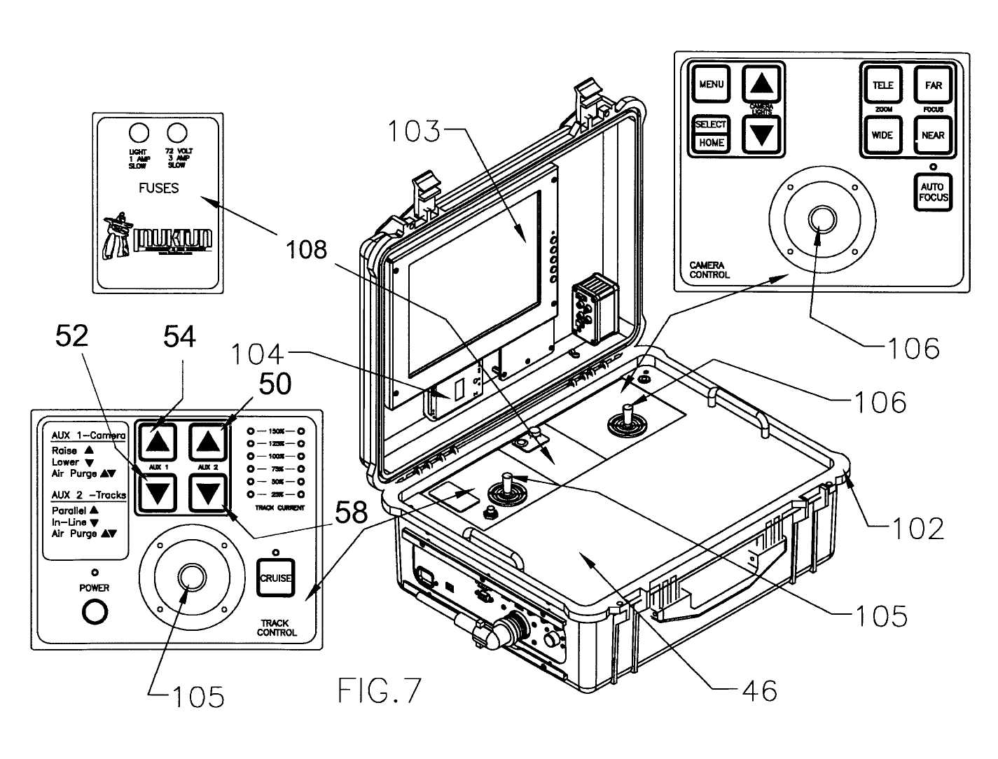

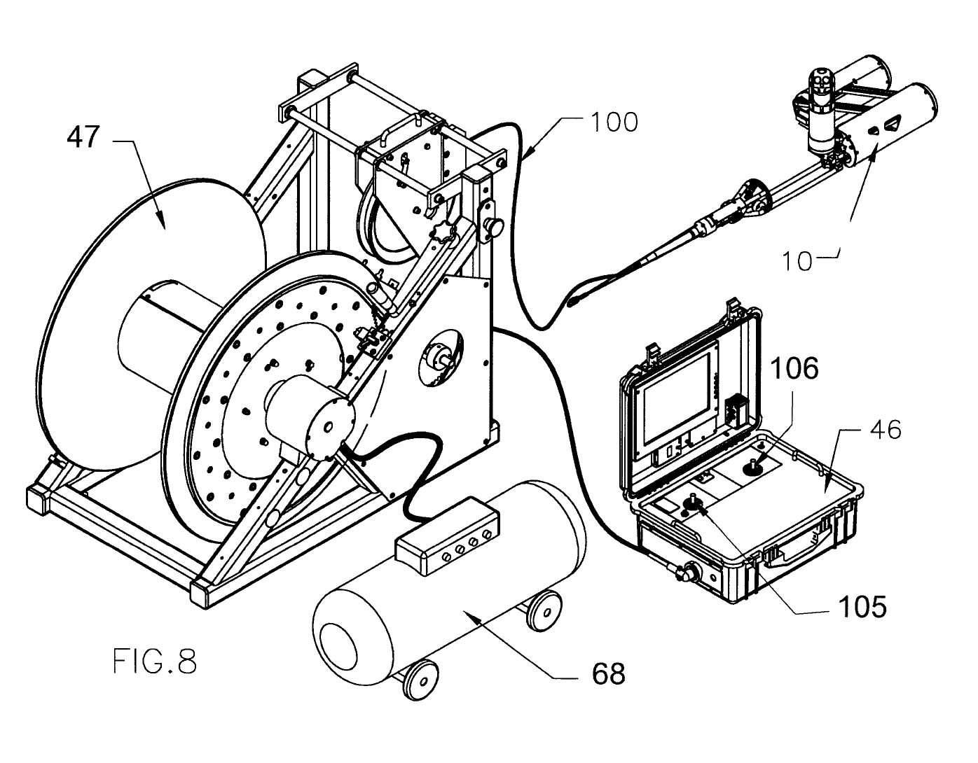

Referring to FIG. 8, robot 10 is controlled via a controller 46. Referring to FIG. 7, there is illustrated a simplified control panel portion of controller 46. The complete controller 46 comes in an impact resistant case 102 and includes a video monitor 103 to receive images broadcast by the camera 34 shown in FIG. 1, a video recorder 104 to record images and a control joystick 105 for manouvering robot 10. A fuse display 108 is provided. Controller 46 also has a camera joy stick 106 for controlling the camera 34 illustrated in FIG. 1.

Referring to FIG. 3, robot 10 is lowered on a tether 100 illustrated in FIG. 8. The tether 100 is a 1500-foot (450 meter) bundle of cable and conduits, only a remote end of which is illustrated in the Figures. Referring to FIG. 8, tether 100 is spooled from a 1-HP winch 47. Compressed air passes to robot 10 through tether 100 from an external air compressor 68. A pneumatic slip ring (not shown) is provided at a remote end of tether 100 to allow for connection to the external air compressor 68.

Referring to FIG. 3, the positioning of first body 12 and second body 18 on a common axis 26 when in the insertion position allows for tunnel entry through a restriction as small as a 6″ diameter borehole 38. Referring to FIG. 4, once robot 10 has passed through the restriction such as borehole 38, pneumatic actuators 28 are activated to reconfigure robot 10 from in-line insertion position as illustrated in FIG. 3, to the operative position as illustrated in FIG. 4. It must be noted that the operative position need not be precisely as illustrated. For example, if robot 10 were exploring vertical ducting or piping the operative position might have the first track 16 and the second track 22 oriented in opposed relation. Once robot 10 is in the operative position, pneumatic actuator 35 is used to raise camera 34 to the operative position, as shown in FIG. 1 and FIG. 2. Once raised to the operational position, camera 34 provides a 360° view of surroundings.

There are also some supplementary features that are worthy of note as they serve to enhance operation of robot 10. Referring to FIG. 1 and FIG. 2, vertical tether swivel 42 provides pivotal movement required for robot insertion and robot recovery through the borehole 38. Referring to FIG. 2, a small auxiliary camera 44 is mounted near an end 45 of second body 18 of robot 10 to provide visibility while navigating borehole 38.

### Set-up and Operation:

Referring to FIG. 1 through 8, the set up and operation of Robot 10 will now be described. Referring to FIG. 8, controller 46 and winch 47 are to be used in a dry, covered environment only. The presence of water will adversely affect their performance. It is preferred that controller 46 operate in temperatures between 0° and 40° C. although, if desired, controller 46 could be modified for use in wet environments or environments of extreme heat or extreme cold. Tether 100 is resistant to dust, sand and water to a depth of 5 feet. Tether 100 is only sealed when connected to robot 10. It is recommended, that when tether 100 and robot 10 are separated for transport or storage, the connection between them should be capped to keep out dust, sand, or other foreign matter. Robot 10 can operate in dry sand or standing water up to five feet.

Referring to FIG. 3, robot 10 is suspended from tether 100 in the insertion position in preparation for insertion into borehole 38. Robot 10 is lowered until second track 22 of second body 18, just touches a floor 48 of a tunnel 40. The operator then drives robot 10 forward and slowly lowers robot 10 by the length of one of the second tracks 22.

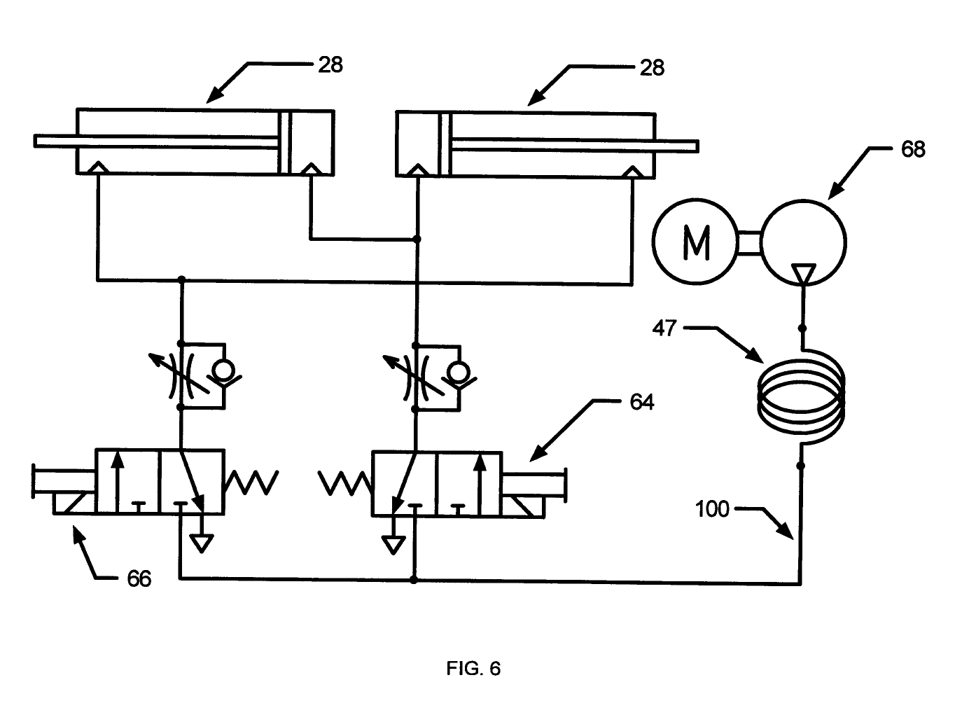

Referring to FIG. 4, pneumatic actuators 28 are then employed to reconfigure first body 12 and second body 18 from the insertion position to the operative position. Referring to FIG. 7, parallel button 50 on controller 46 is pressed. Referring to FIG. 6, this causes the second “expand” pneumatic valve 64 to be actuated allowing compressed air to flow to the extension side of actuators 28. The second “contract” pneumatic valve 66 un-actuates which allows the air to exhaust to atmosphere. The difference in pressure on each side of the actuators 28 causes them to extend. Referring to FIG. 2, actuators 28 are connected to connective linkage 24 that move as actuators 28 extend. This causes first body 12 and second body 18 to start into the operative position illustrated in FIG. 4. At this point it is necessary for the operator to assist by driving the first track 16 and the second track 22 as shown in FIG. 4. When moving to the operative position illustrated in FIG. 4, further assistance can be provided by the operator through the joystick 105 illustrated in FIG. 7.

Referring to FIG. 8, the joystick 105 is moved to the left, in effect attempting to turn robot 10 to the left on the spot. As the configuration takes place, the operator drives forward and lowers robot 10 more until the first body 12 and second body 18 are fully parallel and in the operative position. Referring to FIG. 4, once the first track 16 and the second track 22 are in the operative position, actuators 28 will hold them in position. The operator then continues to lower robot 10 until it is crawling along the bottom floor 48. The operator can then raise camera 34.

Referring to FIG. 8, in order to drive the robot 10, the tether 100 is used to electrically connect the controller 46 to the first track 16 and the second track 22. The tether 100 has two wires (not shown) for the first track 16 and two wires (not shown) for the second track 22 illustrated in FIG. 2. Referring to FIG. 8, to drive the robot 10 forward, the operator moves the track joystick 105 on the controller 46 in an upward direction. This causes current to flow through the tether 100 to both track motors (not shown). Referring to FIG. 2, this engages the track motors and the first track 16 and the second track 22 move in a forward direction. Joystick 105 is connected electrically, however it will be appreciated that it could also be connected pneumatically or otherwise.

Referring to FIG. 8, to turn the robot 10 to the left, the operator moves the track joystick 105 to the left. This again causes current to flow to the track motors. Referring to FIG. 2, in this case, the current to the first track 16 and the second track 22 is biased so that the second track 22 goes in a reverse direction and the first track 16 goes in a forward direction. This causes the robot 10 to move to the left.

Referring to FIG. 8, to drive the robot 10 in reverse, the operator moves the track joystick 105 on the controller 46 down. This causes a reversed biased current to flow through the tether 100 to both track motors. Referring to FIG. 2, this engages the track motors and the first track 16 and the second track 22 move in a reverse direction.

Referring to FIG. 8, to turn the robot 10 to the right, the operator moves the track joystick 105 to the right. This again causes current to flow to the track motors. In this case, the current to the first track 16 and the second track 22 as illustrated in FIG. 2, is biased so that the first track 16 goes in a reverse direction and the second track 22 goes in a forward direction. This causes the robot 10 to move to the right.

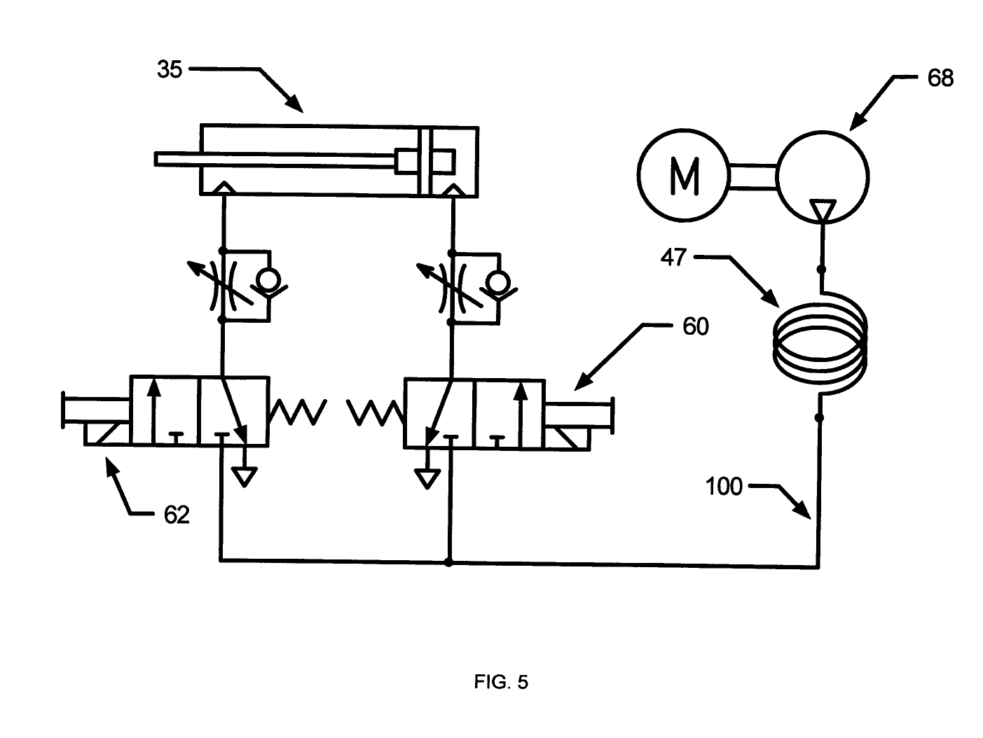

Referring to FIG. 8, the on surface air compressor 68 connected to tether 100 keeps a sufficient supply of compressed air available to the system. Referring to FIG. 7, pressing camera raise button 54 on controller 46 initiates the lifting of camera 34 illustrated in FIG. 1. Referring to FIG. 5, this affects both the first “expand” valve 60 and the first “contract” pneumatic valve 62. When camera raise button 54 is pressed as illustrated in FIG. 7, first “expand” pneumatic valve 60 as illustrated in FIG. 5. is actuated to allow compressed air to flow to the extension side of the actuator 35. Referring to FIG. 5, the first “contract” pneumatic valve 62 un-actuates which allows the air to exhaust to atmosphere. The difference in pressure on the two sides of actuator 35 causes it to extend. Referring to FIG. 2, actuator 35 is connected to mechanical linkages 56 that move as actuator 35 extends. This causes camera 34 to raise and be held in position. It may take up to 30 seconds for camera 34 to raise or lower.

To recover robot 10, the operator will need to drive it to borehole 38 as illustrated in FIG. 3. Camera 34 will then be lowered. Referring to in FIG. 7, to lower camera 34 press camera lower button 52. This works in reverse to raise camera 34. Referring to FIG. 5, first “contract” pneumatic valve 62 is activated to allow compressed air to flow to the contract side of actuator 35 and the first “expand” pneumatic valve 60 un-actuates exhausting the compressed air to atmosphere. Referring to FIG. 2, the pressure difference on the two sides of actuator 35 causes it to contract and this moves the mechanical linkages 56 causing camera 34 to lower and be held in position. Pressing both camera raise button 54 and lower button 52 illustrated in FIG. 7, together un-actuates both first “expand” pneumatic valve 60 and first “contract” pneumatic valve 62 illustrated in FIG. 5, allowing the first “expand” pneumatic valve 60 and the first “contract” pneumatic valve 62 of actuator 35 to exhaust the compressed air to atmosphere thereby permitting free movement of the camera linkages 56. Referring to FIG. 5, when both first “expand” pneumatic valve 60 and first “contract” pneumatic valve 62 of the actuator 35 have been exhausted, the linkages 56 illustrated in FIG. 1, will be “limp” and able to move freely.

Connective linkage 24 should then be configured to the insertion position as illustrated in FIG. 3. To configure the connective linkage 24 with the first track 16 and the second track 22 in the insertion position as illustrated in FIG. 3, press the Inline button 58 shown on FIG. 7. Referring to FIG. 6, second “contract” pneumatic valve 66 is now activated to allow compressed air to flow to the contract side of actuators 28 and the second “expand” pneumatic valve 64 un-actuates exhausting the compressed air to atmosphere. The pressure difference on both sides of actuators 28 cause them to contract and this moves connective linkage 24 and starts moving first body 12 and second body 18 into the insertion position as illustrated in FIG. 3. The operator can assist the pneumatic mechanism by driving the first track 16 and the second track 22 illustrated in FIG. 2. When moving to the insertion position illustrated in FIG. 3, this assistance is provided by moving the track control joystick directly RIGHT, in effect attempting to turn robot 10 to the right on the spot. Referring to FIG. 7, in order to purge actuators 28, the operator presses both the “operative” parallel position button 50 and “insertion” in-line position button 58 together permitting the linkages 56 configuration to go “limp”. The operator can then begin lifting robot 10 up through borehole 38 on the end of tether 100. As robot 10 is being lifted, it will move to the insertion position. Robot 10 can then be lifted up through and out borehole 38.

In the illustrated embodiment, the payload carried by the robot has been shown to be a camera. It will be appreciated, that the movement and operation of the robot does not change regardless of the nature of the payload. The robot can be designed to carry a selected payload. The payload of the robot illustrated is approximately 100 pounds. It will also be noted that, just as the camera is shifted from an insertion position to an operative position; the selected payload can be shifted from an insertion position to an operative position.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A robot reconfigurable for insertion through an opening, comprising:
a first body supporting a first ground engaging drive;
a second body supporting a second ground engaging drive;
a pivoting connective linkage between the first body and the second body, the connective linkage having an operative position in which the first body and the second body are in parallel spaced relation and an insertion position in which the first body and the second body are aligned on a common axis; and
an actuator for moving the connective linkage from the insertion position to the operative position.

2. The robot of claim 1, wherein:
the first body is elongated and has a first longitudinal axis and supports the first ground engaging drive positioned along the first longitudinal axis, with movement of the first body being in a direction defined by the first longitudinal axis; and
the second body is elongated and has a second longitudinal axis and supports the second ground engaging drive positioned along the second longitudinal axis with movement of the second body being in a direction defined by the second longitudinal axis.

3. The robot of claim 1, wherein the connective linkage is a parallelogram linkage.

4. The robot of claim 1, wherein the connective linkage is moved from the operative position to the insertion position by force of gravity.

5. The robot of claim 1, wherein the actuator is a telescopic cylinder expanded by a supply of working fluid.

6. The robot of claim 5, wherein the working fluid is compressed air.

7. The robot of claim 1, wherein the ground engaging drive is an endless track with a motive force propelling the ground engaging drive.

8. A robot reconfigurable for insertion through an opening, comprising:
an elongated first body having a first longitudinal axis and supporting a first ground engaging endless track positioned along the first longitudinal axis, with movement of the first body being in a direction defined by the first longitudinal axis;
an elongated second body having a second longitudinal axis and supporting a second ground engaging endless track positioned along the second longitudinal axis with movement of the second body being in a direction defined by the second longitudinal axis;
a pivoting parallelogram connective linkage between the first body and the second body, the connective linkage having an operative position in which the first body and the second body are in parallel spaced relation and an insertion position in which the first longitudinal axis of the first body and the second longitudinal axis of the second body are aligned; and
at least one fluid actuated telescopically expandable actuator exerting a force upon the connective linkage to move the connective linkage from the insertion position to the operative position; and
having a maximum payload of approximately 100 pounds.

9. The robot of claim 8, wherein the connective linkage is moved from the operative position to the insertion position by force of gravity.

10. The robot of claim 8, wherein a working fluid for expanding the actuator is compressed air.

11. The robot of claim 8, wherein there are two actuators, one acting against each arm of the connective linkage.

12. The robot of claim 8, wherein the payload is a working instrument which is pivotally attached to at least one of the first body or the second body, the working instrument being pivotally movable between an insertion position along the first longitudinal axis of the first body or the second longitudinal axis of the second body to which it is mounted and an operative position in angular relation to the first body or the second body to which it is mounted, and an ancillary actuator being provided to move the working instrument between the insertion position and the operative position.

13. The robot of claim 12, wherein the working instrument is a camera.

14. A system for inserting a robot through an opening, comprising;
a robot reconfigurable for insertion through an opening, the robot having a first body supporting a first ground engaging drive, a second body supporting a second ground engaging drive, a pivoting connective linkage between the first body and the second body, the connective linkage having an operative position in which the first body and the second body are in parallel spaced relation and an insertion position in which the first body and the second body are aligned on a common axis, at least one fluid actuated telescopically expandable actuator for moving the connective linkage from the insertion position to the operative position, and having a maximum payload of approximately 100 pounds;
at least one tether in operable communication with the at least one fluid actuated telescopically expandable actuator, the tether incorporating at least means for distributing power, means for distributing control signals and means for distributing fluids to the at least one fluid actuated telescopically expandable actuator; and
at least one remote control system in operable communication with the at least one tether.

15. The system of claim 14, wherein the means for distributing fluids to the at least one fluid actuated telescopically expandable actuator is a conduit in fluid communication with a compressor supplied with working fluid from a fluid container.

16. The system of claim 15, wherein the working fluid is compressed air

17. A method of inserting a robot into an opening, comprising;
providing a robot reconfigurable for insertion through an opening, the robot having a first body supporting a first ground engaging drive, a second body supporting a second ground engaging drive, a pivoting connective linkage between the first body and the second body, the connective linkage having an operative position in which the first body and the second body are in parallel spaced relation and an insertion position in which the first body and the second body are aligned on a common axis, at least one fluid actuated telescopically expandable actuator for moving the connective linkage from the insertion position to the operative position;
providing a least one tether in operable communication with the at least one fluid actuated telescopically expandable actuator, the tether incorporating at least means for distributing power, means for distributing control signals and means for distributing fluids to the at least one fluid actuated telescopically expandable actuator;
providing at least one remote control system in operable communication with the at least one tether;
suspending the robot from the tether in the insertion position;
inserting the robot into a borehole;
lowering the robot lowered until the second ground engaging drive of the second body to engage an underlying surface;
distributing a control signal to activate means for distributing power to the second ground engaging drive to drive the robot forward;
lowering the robot by a length of the second ground engaging drive; and
distributing a control signal to activate the means for distributing fluids to actuate the at least one fluid actuated telescopically expandable actuator to move the connective linkage from the insertion position to the operative position.
